(19) United States
(12) Patent Application Publication
(10) Pub. No.: US 2003/0016420 A1
(43) Pub. Date: Jan. 23, 2003

(54) Method and apparatus for aligning a light beam onto an optical fiber core

(76) Inventors: Roger P. Holmstrom, St. Charles, IL (US); Nicholas J. Scholtes, Joliet, IL (US)

Correspondence Address: Lawrence M. Cho, Tellabs Operations, Inc., 4951 Indiana Avenue, MS 16, Lisle, IL, 60532, US

(21) Appl. No.: 09/910,147

(22) Filed: Jul. 20, 2001

(51) Int. Cl. H04B 10/08; H04B 10/00

(52) U.S. Cl. 359/159; 359/110

(57) ABSTRACT

A beam alignment system according to a first embodiment of the present invention is disclosed. The beam alignment system includes a signal detector that is positioned in a path of a beam carrying a traffic signal having a first wavelength and an alignment signal having a second wavelength. The signal detector allows a signal having the first wavelength to be transmitted and takes an intensity measurement of the alignment signal. The beam alignment system includes a signal alignment unit that compares the intensity measurement of the alignment signal to determine whether the alignment signal is aligned on the signal detector. The beam alignment unit includes a signal director that adjusts the path of the beam on the signal detector in response to the determination of the signal alignment unit.

### FIELD OF THE INVENTION

The present invention relates to the field of signal transmission on optical cables. More specifically, the present invention relates to techniques for aligning a beam onto a core of an optical cable.

### BACKGROUND OF THE INVENTION

Optical interconnects may require alignment of an optical beam traveling through free space onto the core of an optical fiber. The optical beam must be focused onto the fiber core within sub-micron tolerance in order to preserve maximum coupled power to the fiber. One technique in the past used for aligning a beam onto a fiber core required taking a signal tap from a traffic signal. The intensity level of the signal tap would be compared with a measured intensity level of a signal tap from a previously aligned beam to determine whether the traffic signal was aligned. The results from the comparison would be used to adjust the path taken by the traffic signal.

This approach had several drawbacks. One drawback of this approach was that signal taps resulted in the loss of optical power from the traffic signal. Since many optical systems operated with a tight power budget, introducing additional loss to the optical system was undesirable. Another drawback of this approach was that since the intensity level of the traffic signal was used to align the beam onto the fiber core, alignment and verification of alignment was not achievable before at least some of the traffic signal was already transmitted. Still another drawback of this approach was the additional cost associated with hardware required for taking the signal tap from the traffic signal such as the coupler splitter.

Thus, what is needed is a method and apparatus for aligning a beam onto a fiber core that conserves the power level of the traffic signal, aligns the beam in a timely manner, and does not require the optical system to incur undesirable costs.

### SUMMARY OF THE INVENTION

A beam alignment system according to a first embodiment of the present invention is disclosed. The beam alignment system includes a signal detector that is positioned in a path of a beam carrying a traffic signal having a first wavelength and an alignment signal having a second wavelength. The signal detector allows a signal having the first wavelength to be transmitted and takes an intensity measurement of the alignment signal. The beam alignment system includes a signal alignment unit that compares the intensity measurement of the alignment signal to determine whether the alignment signal is aligned on the signal detector. The beam alignment unit includes a signal director that adjusts the path of the beam on the signal detector in response to the determination of the signal alignment unit. According to one embodiment, the beam alignment unit includes a beam adjustment algorithm that follows a common optimization scheme such as a “hill climbing” algorithm.

A beam alignment system according to a second embodiment of the present invention is disclosed. The beam alignment system includes a signal detector that absorbs a portion of a traffic signal. The signal detector takes an intensity measurement of the portion of the traffic signal. The beam alignment system includes a signal alignment unit that compares the intensity measurement to determine whether the traffic signal is aligned on the signal detector. The beam alignment system includes a signal director that adjusts the path of the traffic signal on the signal detector in response to the determination of the signal alignment unit. According to one embodiment the beam alignment unit includes a beam adjustment algorithm that follows a common optimization scheme such as a “hill climbing” algorithm. The signal detector may be in the form of a quadrature detector for which the beam steering algorithm is simplified by using the intensity gradients.

A first method for managing a traffic signal is disclosed. A beam carrying the traffic signal having a first wavelength and an alignment signal having a second wavelength is transmitted to a signal detector that transmits signals having the first wavelength. According to one embodiment, the mechanism by which the alignment signal is projected onto the detection unit may involve factory calibration settings. These factory calibration settings may have been obtained with the use of the subject beam alignment system. Intensity measurements of the alignment signal are obtained on the signal detector. It is determined whether the alignment signal is aligned with the signal detector in response to the intensity measurements. The path of the beam to the signal detector is adjusted in response to the determination.

A second method for managing a traffic signal according to the present invention is disclosed. A beam carrying the traffic signal having a first wavelength is transmitted to a signal detector. The signal detector transmits signals having the first wavelength. According to one embodiment, partially absorbs signals having the first wavelength. Intensity measurements of the traffic signal on the signal detector are obtained. It is determined whether the traffic signal is aligned with the signal detector in response to the intensity measurements. The path of the beam to the signal detector is adjusted in response to the determination.

### BRIEF DESCRIPTION OF THE DRAWINGS

FIG. 1 is a block diagram illustrating a first embodiment of a beam alignment system according to the present invention;

FIG. 2 is a conceptual diagram of the beam alignment system of FIG. 1;

FIG. 3 illustrates a signal detector according an embodiment of the present invention;

FIG. 4a illustrates a first example of a beam carrying a traffic signal and an alignment signal incident on the signal detector;

FIG. 4b illustrates the intensity measurements of the alignment signal of FIG. 4a taken from the signal detector;

FIG. 5a illustrates a second example of a beam carrying a traffic signal and an alignment signal incident on the signal detector;

FIG. 5b illustrates the intensity measurements of the alignment signal of FIG. 5a taken from the signal detector;

FIG. 6 illustrates the signal detector and the focusing unit according to an embodiment of the present invention;

FIG. 7 is a block diagram illustrating a second embodiment of a beam alignment system according to the present invention;

FIG. 8 is a conceptual diagram of the beam alignment system of FIG. 7; and

FIG. 9 is a flow chart illustrating a first method for aligning a beam according to the present invention.

### DETAILED DESCRIPTION

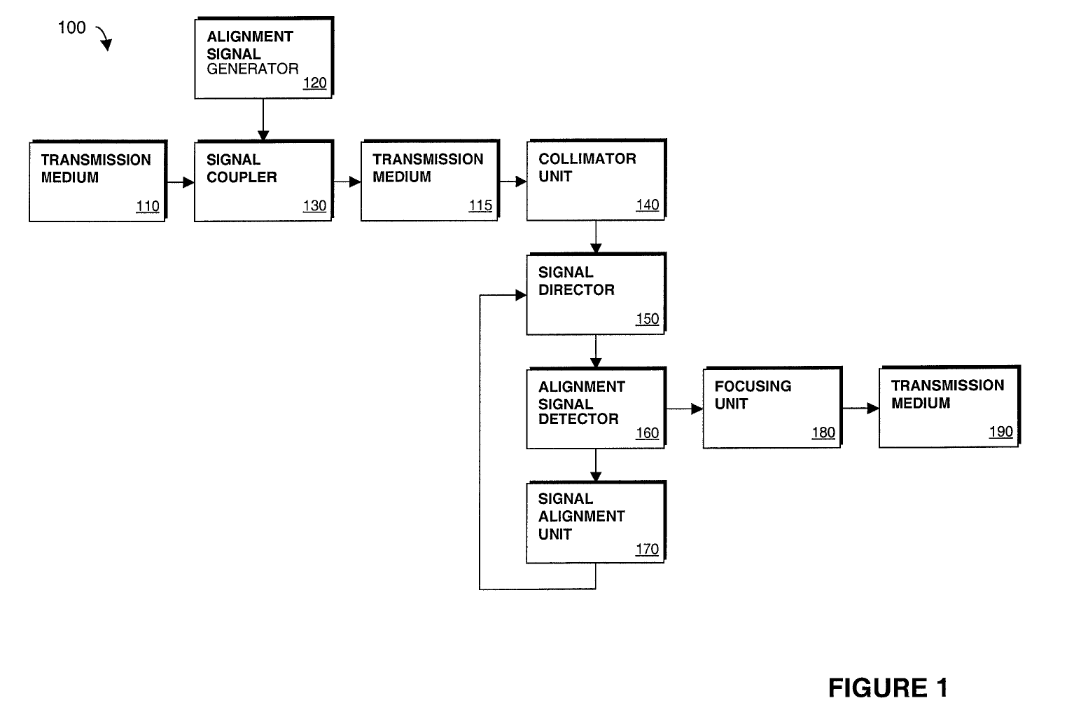

FIG. 1 is a block diagram illustrating a first embodiment of a beam alignment system 100 according to the present invention. Block 110 represents a first transmission medium. The first transmission medium 110 may be used to transmit traffic signals from a first location. The traffic signals may include, for example, optical signals used for communication. The traffic signal may be a light signal having a first wavelength. Block 190 represents a second transmission medium. The second transmission medium 190 may be used to transmit the traffic signal to a second location. The beam alignment system 100 allows a beam carrying the traffic signal from the first transmission medium 110 to be aligned on the second transmission medium 190. According to an embodiment of the beam alignment system 100, the first transmission medium 110 may be a first optical cable having a core and cladding and the second transmission medium 190 may be a second optical cable having a core and cladding. In this embodiment, the beam alignment system 100 allows the beam carrying the traffic signal from the first optical cable to be aligned onto the core of the second optical cable.

Block 120 represents an alignment signal generator. The alignment signal generator 120 generates an alignment signal. The alignment signal may be a signal having a second wavelength which is different from that of the traffic signal. According to an embodiment of the signal alignment system 100, the alignment signal generator 120 is a laser source and the alignment signal is generated from a light emitting diode (LED) or a laser.

Block 130 represents a signal coupler. The signal coupler 130 couples the alignment signal from the alignment signal generator 120 with the traffic signal from the first transmission medium 110 such that the signals travel together in a same beam. According to an embodiment of the signal alignment system 100, the signal coupler 130 allows a beam carrying the traffic signal from the first transmission medium 110 and the alignment signal from the alignment signal generator 120 to be transmitted onto the third transmission medium 115 represented by block 115.

Block 140 represents a collimator unit. The collimator unit 140 receives the beam carrying the traffic signal and the alignment signal from the third transmission medium 115 and collimates the signals into a focused beam. According to an embodiment of the beam alignment system 100, the collimator unit 140 may be a lens. The lens may include the material gallium phosphide (GaP) or other materials suitable for fabricating optical dectors.

Block 150 represents a signal director. The signal director 150 directs a path of the beam carrying the traffic signal and the alignment signal from the collimator unit 140 onto a signal detector represented by block 160. According to an embodiment of the beam alignment unit 100, free space separates the collimator unit 140 and the signal director 150. By free space, it is meant that there is no light guiding property in the media, i.e., the index of refraction of the media is relatively uniform and homogeneous. The signal director 150 directs the beam carrying the traffic signal and the alignment signal by reflecting the beam towards the signal detector 160. According to an embodiment of beam alignment system 100, the signal director 150 includes a plurality of beam steering units. For example, micro-electromechanical systems (MEMS) may be implemented as the beam steering units.

In another embodiment, the signal collimator 140 and the signal director 150 may be the same unit, in which case the collimator is directed at the signal alignment detector 160.

The signal detector 160 receives the beam carrying the traffic signal and the alignment signal from the signal director 150. The signal detector 160 includes material that transmits signals contained on the first wavelength but absorbs at least a portion of signals contained on the second wavelength. The signal detector 160 thus absorbs at least a portion of the alignment signal and transmits the traffic signal from the signal director 150. The signal detector 160 determines the intensity of the alignment signal from the portions absorbed. The signal detector 160 may, for example, take a plurality of measurements of the alignment signal at a plurality of locations where the alignment signal is incident on the signal detector 160. According to an embodiment of the beam alignment system 100, the signal detector 160 may be a quadrature detector.

Block 180 represents a focusing unit. The focusing unit 180 receives the beam carrying the traffic signal from the signal detector 160. The focusing unit 180 focuses the beam carrying the traffic signal onto the second transmission medium 190. The signal detector 160, focusing unit 180, and second transmission medium 190 are positioned in the beam alignment system 100 such that when an alignment signal is aligned on the signal detector 160, the traffic signal is also aligned on the second transmission medium 190. It should be appreciated that the focusing unit 180 may also be positioned between the signal director 150 and the alignment signal detector 160. According to an embodiment of the beam alignment system 100, the positioning accuracy of the signal detector 160, focusing unit 180, and second transmission medium 190 is established in planar processing prior to assembly. It should also be appreciated that the focussing unit 180 and the alignment signal detector may be a single unit.

Block 170 represents a signal alignment unit. The signal alignment unit 170 receives the intensity measurements of the alignment signal from the signal detector 160. The signal alignment unit 170 determines whether the alignment signal is aligned with the signal detector 160 in response to the intensity measurements of the alignment signal. If the alignment signal is not aligned with the signal detector 160, the signal alignment unit 170 determines how the signal director 150 should adjust the path of the beam carrying the traffic signal and the alignment signal such that the alignment signal would be aligned on the signal detector 160. In order to improve detection sensitivity to establish connection verification, the alignment signal 120 may be encoded with a signal such as a pilot tone. A pilot tone is a radio frequency small-amplitude modulation of the light beam, in this case, the alignment beam.

According to an embodiment of the beam alignment signal 100, the alignment signal may be generated and transmitted to the alignment signal detector 160 before the traffic signal. This would allow the signal detector 160, signal alignment unit 170, and signal director 150 to align a beam from the third transmission medium 115 onto the alignment signal detector 160 before the traffic signal is transmitted from transmission medium 110. This provides the benefit of insuring an aligned beam for carrying traffic signals while minimizing the loss of traffic data.

Examples are given of how the components of the beam alignment system 100 may be implemented. It should be appreciated that the transmission media 110, 115, and 190, the alignment signal generator 120, signal coupler 130, collimator unit 140, signal director 150, signal detector 160, signal alignment unit 170, and focusing unit 180 may be implemented using any known circuitry, component or technique. Alternatively, the beam alignment system 100 may include additional components or be implemented without some of the components described.

According to an embodiment of the present invention, there is a one-to-one mapping of the transmission media 110, 115, and 190, the alignment signal generator 120, signal coupler 130, collimator unit 140, signal director 150, signal detector 160, and focusing unit 180 where a plurality of these units are implemented in the beam alignment system 100. In this embodiment, the signal alignment unit 170 may be a processor that coordinates the positioning of the signal directors 150.

According to an embodiment of the present invention, the transmission medium 110, alignment signal generator 120, signal coupler 130, transmission medium 115, collimator unit 140, and signal director 150 may be associated with a first type of sub-system and the alignment signal detector 160, signal alignment unit 170, focusing unit 180, and transmission medium 190 may be associated with a second type of sub-system. In this embodiment, an assembly may include a plurality of first sub-systems and a plurality of second sub-systems where a signal may be transmitted on one of the first sub-systems and be directed to one of the second sub-systems via a signal director in the first sub-system.

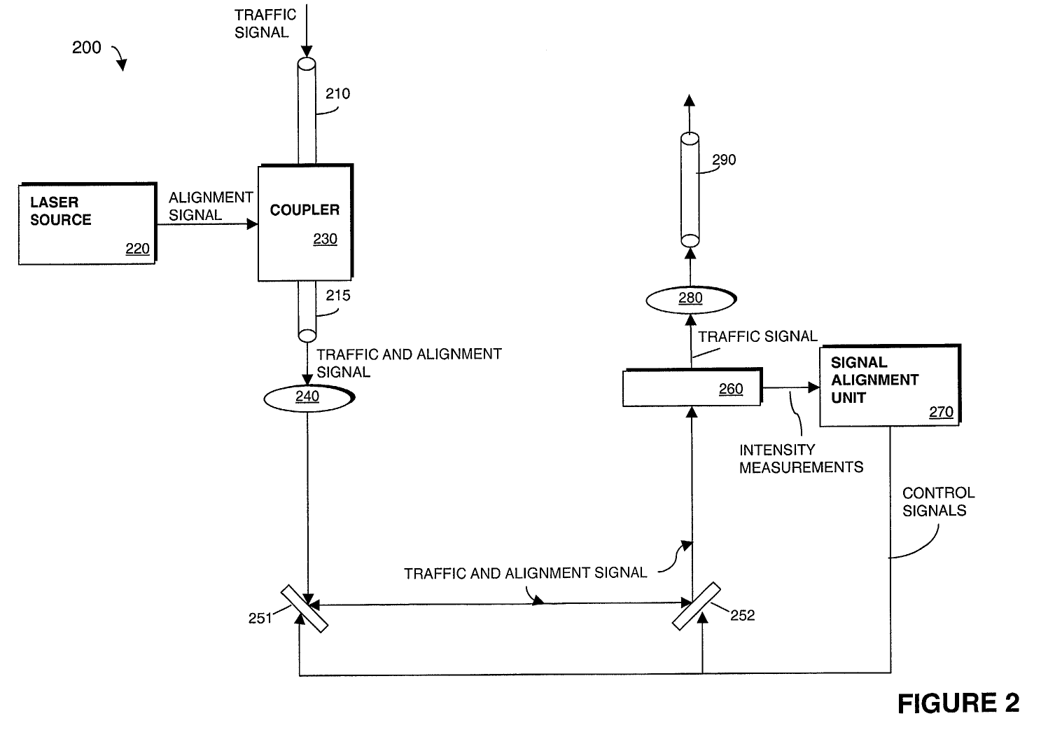

FIG. 2 is a conceptual diagram of the beam alignment system of FIG. 1. The beam alignment system 200 is an embodiment of the beam alignment system 100 shown in FIG. 1. The beam alignment system 200 includes a first optical cable 210 that transmits a traffic signal from a first location. The traffic signals may include, for example, optical signals used for communication. The traffic signal may be a light signal having a first wavelength. The beam alignment system 200 includes a second optical cable 290 that transmits the traffic signal to a second location. The beam alignment system 200 aligns a beam carrying the traffic signal from the first optical cable 210 onto the core of the second optical cable 290. According to an embodiment of the present invention, there are a plurality of first optical cables 210 and a plurality of second optical cables 290 in the alignment system 200. The alignment system aligns any of the cables 210 to any of the cables 290 on a one-to-one basis.

The beam alignment system 200 includes a laser source 220. The laser source 220 generates an alignment signal having a second wavelength which is different from that of the traffic signal. According to an embodiment of the signal alignment system 200, the laser source 220 generates an alignment signal having a wavelength of less than one micron.

The beam alignment system 200 includes a signal coupler 230. The signal coupler 230 couples the alignment signal from the laser source 220 with the traffic signal from the first optical cable 210 such that the signals travel together in the same beam. According to an embodiment of the signal alignment system 200, the signal coupler 230 allows a beam carrying the traffic signal from the first optical cable 210 and the alignment signal from the laser source 220 to be transmitted onto a beam projector 215. According to an alternate embodiment of the beam alignment system 200, the signal coupler allows a beam carrying the traffic signal and the alignment signal to be transmitted directly onto a collimator lens 240.

The beam alignment system 200 includes a collimator lens 240. The collimator lens 240 receives the beam carrying the traffic signal and the alignment signal and collimates the beams. According to an embodiment of the beam alignment system 200, the collimator lens 240 includes the material gallium phosphide (GaP). In one embodiment, the lens may include detector elements. In another embodiment, the lenses required for a plurality of transmission media may be fabricated on a single substrate (lenslet array).

The beam alignment system 200 includes beam steering elements 251 and 252. In one embodiment, the beam steering elements 251 and 252 may be MEMS elements. In another embodiment, the beam projector 215, collimator 240, and beam steering 251 may be of a single unit, and the focusing lens 280, the alignment detector 260, and the beam steering unit 252 may be of a single unit. The beam steering elements 251 and 252 direct a path of the beam carrying the traffic signal and the alignment signal from the collimator lens 240 onto a signal detector 260. Although the beam alignment system 200 in FIG. 2 is shown to implement two beam steering elements, it should be appreciated that the beam alignment system 200 may implement only one or any number of beam steering elements. According to an embodiment of the beam alignment unit 200, free space separates the collimator lens 240 and the signal detector 250. The beam steering elements 251 and 252 direct the beam carrying the traffic signal and the alignment signal by reflecting the beam.

The beam alignment system 200 includes a signal detector 260. The signal detector 260 receives the beam carrying the traffic signal and the alignment signal from beam steering element 252. The signal detector 260 includes material that transmits signals having the first wavelength but absorbs at least a portion of the signals having the second wavelength. The signal detector 260 thus absorbs a portion of the alignment signal and transmits the traffic signal from the beam steering element 252. The signal detector 260 determines the intensity of the alignment signal from the portion absorbed. The signal detector 260 may, for example, take a plurality of measurements of the alignment signal at a plurality of locations where the alignment signal is incident on the signal detector 260. According to an embodiment of the beam alignment system 200, the signal detector 260 may be a quadrature detector.

The beam alignment system 200 includes a focusing lens 280. The focusing lens 280 receives the beam carrying the traffic signal from the signal detector 260. The focusing lens 280 focuses the beam carrying the traffic signal onto the core of the second optical cable 290. The signal detector 260, focusing lens 280, and second optical cable 290 are positioned in the beam alignment system 200 such that when an alignment signal is aligned on the signal detector 260, the traffic signal is also aligned on the core of the second optical cable 290. It should be appreciated that the focusing lens 280 may be positioned between beam steering element 251 and the signal detector 260. The focusing lens 280 and the signal detector 260 may be one unit.

The beam alignment system 200 includes a signal alignment unit 270. The signal alignment unit 270 receives the intensity measurements of the alignment signal from the signal detector 260. The signal alignment unit 270 determines whether the alignment signal is aligned with the signal detector 260 in response to the intensity measurements of the alignment signal. If the alignment signal is not aligned with the signal detector 260, the signal alignment unit 270 determines how the beam steering elements 251 and 252 should adjust the path of the beam carrying the traffic signal and the alignment signal such that the alignment signal is aligned on the signal detector 260.

It should be appreciated that the optical cables 210 and 290, laser source 220, signal coupler 230, beam projector 215, collimator lens 240, MEMS mirrors 251 and 252, signal detector 260, signal alignment unit 270, and focusing lens 280 may be implemented using any known circuitry, component or technique. Alternatively, the beam alignment system 100 may include additional components or be implemented without some of the components described.

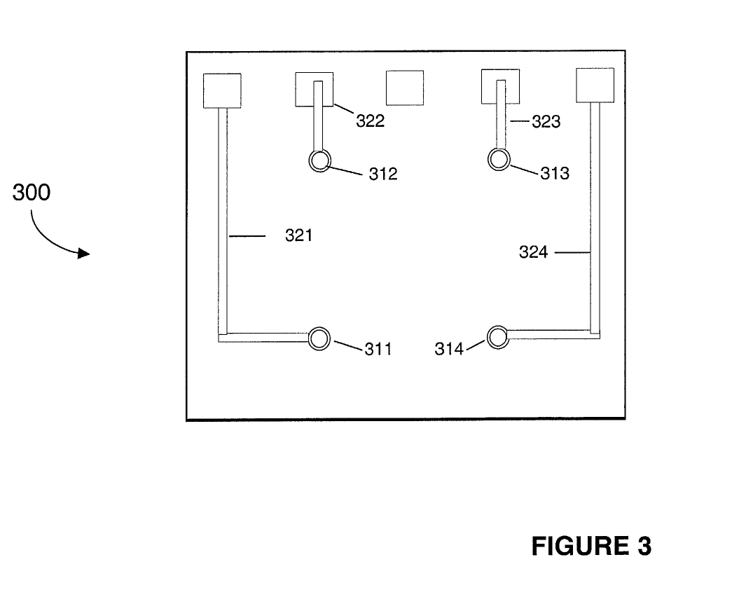

FIG. 3 illustrates an alignment beam detector 300 that is an embodiment of the alignment beam detector 260 shown in FIG. 2. The alignment beam detector 300 includes a plurality of sensors 311-314. Each of the sensors 311-314 measures the intensity of a signal having the second wavelength. According to an embodiment of the alignment beam detector 300, sensors 311-314 are positioned in locations on the alignment beam detector 300 such that when an alignment signal is in alignment with the alignment beam detector 300, the intensity measurements taken from the sensors 311-314 have the same signal strength. The alignment beam detector 300 also includes a trace 321-324 coupled to each of the sensors 311-314 respectively. The traces 321-324 transmit the intensity measurements taken by the sensors 311314 off of the alignment beam detector 300. According to an embodiment of the beam alignment system 200, the alignment beam detector 300 is on a substrate material that includes silicon (Si) or other material that allows the alignment beam detector 300 to transmit signals having the first wavelength. In an embodiment where silicon is used, the sensors 311-314 are ion implants that define p-regions of the alignment beam detector 300. The traces 321-324 include materials such as indium tin oxide, doped silicon, or other materials that transmit signals having the first wavelength. In an alternate embodiment, the alignment beam detector 300 is on a substrate material that includes GaP, and sensors 311-314 include InGaAs, InGaAsP or InP that are grown on the substrate.

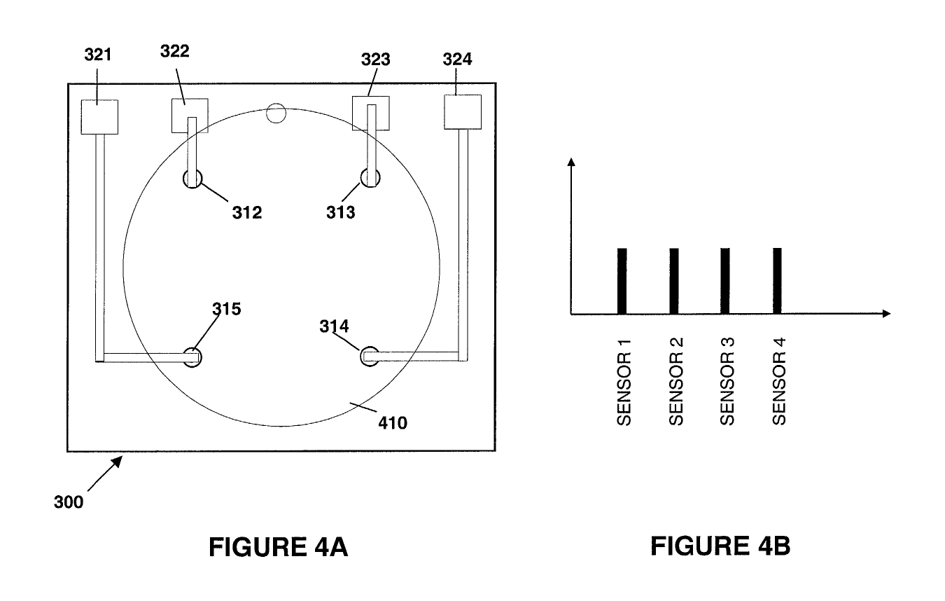

FIG. 4a illustrates a first example of traffic and alignment signals 410 incident on the alignment beam detector 300 of FIG. 3. In this example, the traffic and alignment signals 410 are in alignment with the alignment beam detector 300. The measurements of the intensity of the alignment beam taken from sensors 311-314 are shown in FIG. 4b. In this example, the intensity measurements of the alignment beam taken by the sensors 311-314 are the same signal strength.

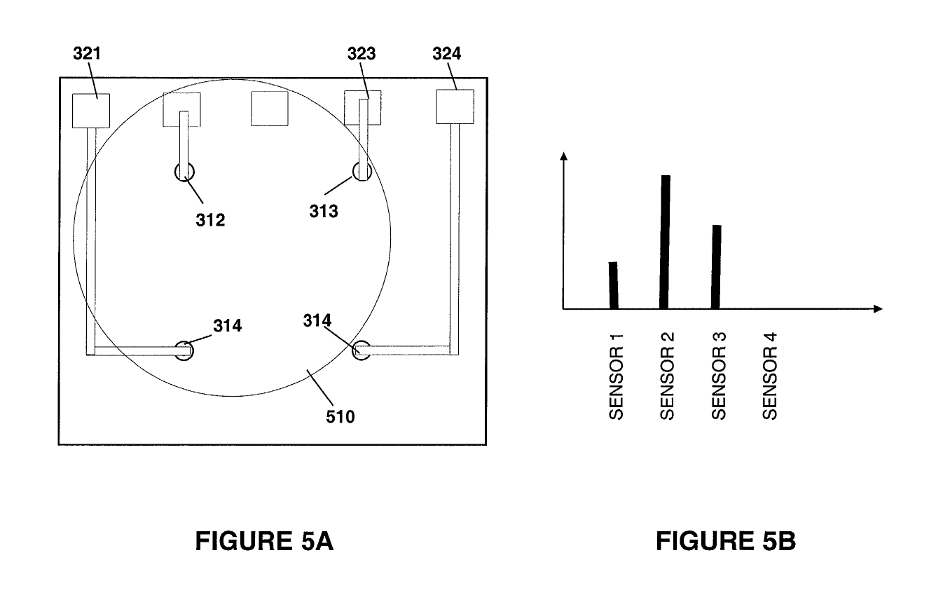

FIG. 5a illustrates a second example of traffic and alignment signals 510 incident on the alignment beam detector 300 of FIG. 3. In this example, the traffic and alignment signals 510 are not in alignment with the alignment beam detector 300. The measurements of the intensity of the alignment beam taken from sensors 311-314 are shown in FIG. 5b. The intensity measurements of the alignment beam taken by the sensors 311-314 are of varying strength. According to an embodiment of the beam alignment system 200, the intensity measurements of an alignment beam that is aligned with the signal detector 300 may be stored in the signal alignment unit 270. The signal alignment unit 270 may compare intensity measurements of an alignment signal taken at a later time with the stored measurements of the aligned alignment signal to determine the position of the alignment signal relative to an aligned alignment signal. The signal alignment unit 270 (shown in FIG. 2) may generate control signals to the beam steering elements 251 and 252 (shown in FIG. 2) or signal director 150 (shown in FIG. 1) to adjust the path of the alignment beam such that it would be alignment with the signal detector 300.

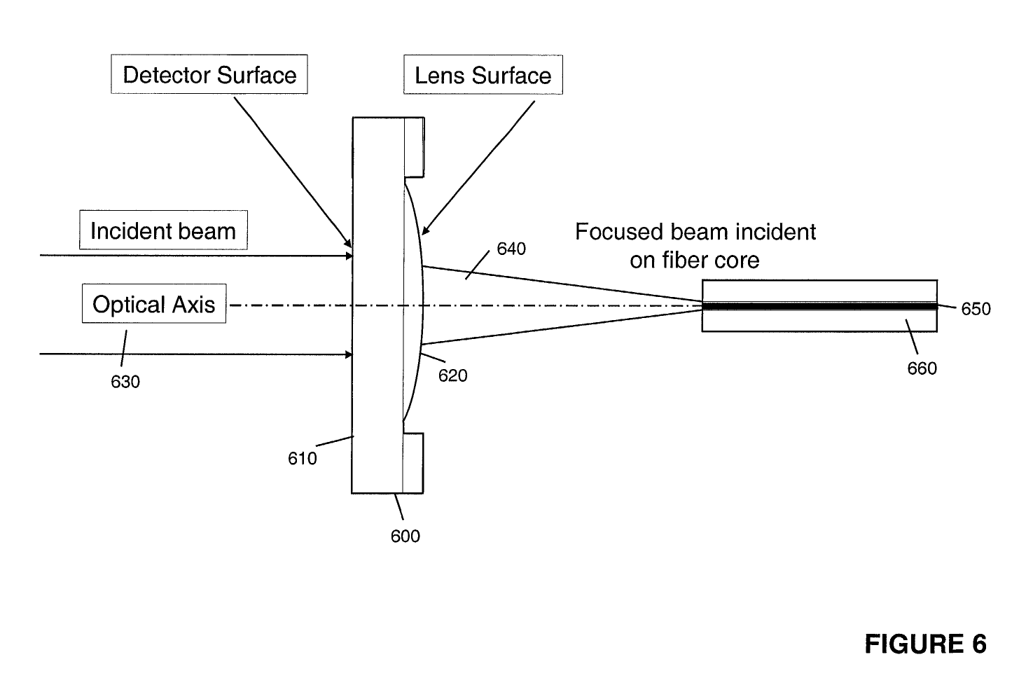

FIG. 6 illustrates a signal detector and a focusing unit according to an embodiment of the present invention. The signal detector shown in FIGS. 1-3 and the focusing unit shown in FIGS. 1-2 may be constructed on a same piece of material. FIG. 6 illustrates an alignment beam detector/focusing unit 600 that includes an alignment beam detector on a first surface 610 of the alignment beam detector/focusing unit 600 and a focusing unit on a second surface 620 of the alignment beam detector/focusing unit 600. A beam 630 that carries a traffic signal and an alignment signal may be incident on the first surface 610. A beam 640 that carries the traffic signal may be transmitted through the second surface 620. The focusing unit on the second surface 620 focuses the beam 640 onto a fiber core 650 of an optical cable 660. It should be appreciated that the alignment beam detector/focusing unit 600 may include silicon (Si), gallium phosphide (GaP) and/or other materials that transmit a signal having the first wavelength and upon which detectors that at least partially absorb the second wavelength can be fabricated. FIG. 6 shows a focusing unit in the form of a plano-convex lens. It should be appreciated that any lens type that provides the proper focussing may be implemented.

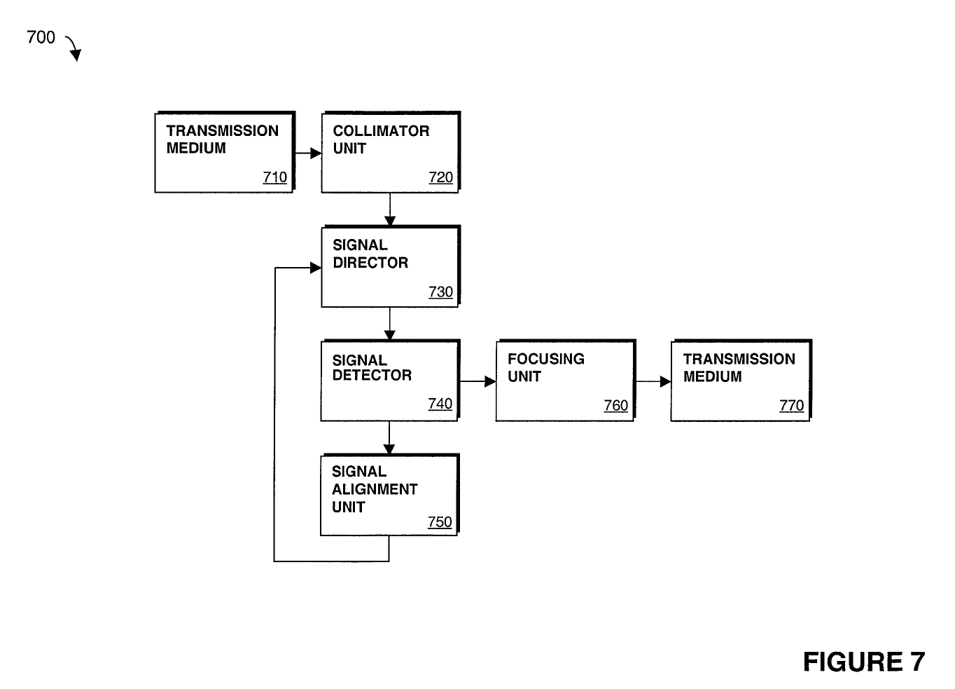

FIG. 7 is a block diagram illustrating a second embodiment of a beam alignment system 700 according to the present invention. Block 710 represents a first transmission medium. The first transmission medium 710 may be used to transmit traffic signals from a first location. The traffic signals may include, for example, optical signals used for communication. The traffic signal may be a light signal having a first wavelength. Block 770 represents a second transmission medium. The second transmission medium 770 may be used to transmit the traffic signal to a second location. The beam alignment system 700 allows a beam carrying the traffic signal from the first transmission medium 710 to be aligned on the second transmission medium 770. According to an embodiment of the beam alignment system 700, the first transmission medium 710 may be a first optical cable having a core and cladding and the second transmission medium 770 may be a second optical cable having a core and cladding. In this embodiment, the beam alignment system 700 allows the beam carrying the traffic signal from the first optical cable to be aligned onto the core of the second optical cable.

Block 720 represents a collimator unit. The collimator unit 720 receives the beam carrying the traffic signal from the second transmission medium 710 and collimates the beam into a focused beam. According to an embodiment of the beam alignment system 700, the collimator unit 140 may be a lens. The lens may include silicon (Si), gallium phosphide (GaP) or other materials suitable for detector fabrication.

Block 730 represents a signal director. The signal director 730 directs a path of the beam carrying the traffic signal from the collimator unit 720 onto a signal detector represented by block 740. According to an embodiment of the beam alignment unit 700, free space separates the collimator unit 720 and the signal detector 740. The signal director 730 directs the beam carrying the traffic signal towards the signal detector 740. According to an embodiment of beam alignment system 700, the signal director 740 includes a plurality of beam steering elements. The beam steering elements may be implemented, for example, by MEMS elements such as MEMS mirrors.

The signal detector 740 receives the beam carrying the traffic signal from the signal director 730. The signal detector 740 includes material that transmits signals having the first wavelength. The signal detector 740 also includes a plurality of sensors (not shown) that absorbs a portion of the traffic signal. The signal detector 740 determines the intensity of the traffic signal from the portion absorbed. The signal detector 740 may, for example, take a plurality of measurements of the traffic signal at a plurality of locations where the traffic signal is incident on the signal detector 740. According to an embodiment of the beam alignment system 700, the signal detector 740 may be a quadrature detector.

Block 760 represents a focusing unit. The focusing unit 760 receives the beam carrying the traffic signal from the signal detector 740. The focusing unit 760 focuses the beam onto the second transmission medium 770. The signal detector 740, focusing unit 760, and second transmission medium 770 are positioned in the beam alignment system 700 such that when a traffic signal is aligned on the signal detector 740, it is also aligned on the second transmission medium 770. According to an embodiment of the beam alignment system 700, the positioning of the signal detector 740, focusing unit 760, and second transmission medium 770 is performed in planar processing during assembly.

Block 750 represents a signal alignment unit. The signal alignment unit 750 receives the intensity measurements of the traffic signal from the signal detector 740. The signal alignment unit 750 determines whether the beam carrying the traffic signal is aligned with the signal detector 740 in response to the intensity measurements of the traffic signal. If the beam carrying the traffic signal is not aligned with the signal detector 740, the signal alignment unit 750 determines how the signal director 730 should adjust the path of the beam carrying the traffic signal such that it is in alignment on the signal detector 740.

Examples are given of how the components of the beam alignment system 700 may be implemented. It should be appreciated that the transmission media 710 and 770, collimator unit 720, signal director 730, signal detector 740, signal alignment unit 750, and focusing unit 760 may be implemented using any known circuitry, component or technique. Alternatively, the beam alignment system 700 may include additional components or be implemented without some of the components described.

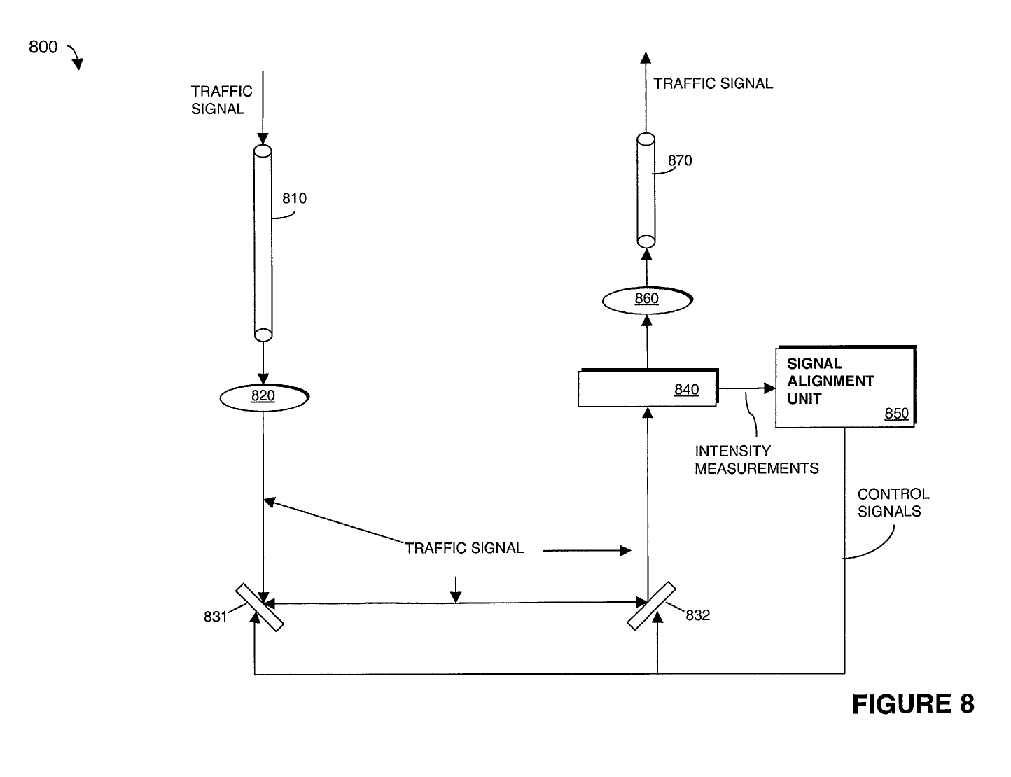

FIG. 8 is a conceptual diagram of the beam alignment system of FIG. 7. The beam alignment system 800 is an embodiment of the beam alignment system 700 shown in FIG. 7. The beam alignment system 800 includes a first optical cable 810 that transmits a traffic signal from a first location. The traffic signals may include, for example, optical signals used for communication. The traffic signal may be in the form of a light signal having a first wavelength. The beam alignment system 800 includes a second optical cable 870 that transmits the traffic signal to a second location. The beam alignment system 800 aligns a beam carrying the traffic signal from the first optical cable 810 onto the core of the second optical cable 870.

The beam alignment system 800 includes a collimator lens 820. The collimator lens 820 receives the beam carrying the traffic signal and collimates the beam into a focused beam. According to an embodiment of the beam alignment system 800, the collimator lens 820 includes silicon (Si), gallium phosphide (GaP), and/or other materials.

The beam alignment system 800 includes a plurality of beam steering elements 831 and 832 to which there are associated a plurality of collimating lenses, detectors, and output fibers. The beam steering elements 831 and 832 direct a path of the beam carrying the traffic signal from the collimator lens 820 onto a signal detector 840. According to an embodiment of the beam alignment unit 800, free space separates the collimator lens 820 and the signal detector 840. The beam steering elements 831 and 832 direct the traffic signal by pointing the beam carrying the traffic signal onto the signal detector 840.

The beam alignment system 800 includes a signal detector 840. The signal detector 840 receives beam carrying the traffic signal from beam steering element 832. The signal detector 840 includes material that, in one embodiment, transmits signals having the first wavelength while absorbing signals having a second wavelength or, in a second embodiment, have regions that partially absorb the traffic signal having a first wavelength. The signal detector 840 also includes a plurality of sensors (not shown). The signal detector 840 may, for example, take a plurality of measurements of the traffic or alignment signal at a plurality of locations where the beam is incident on the signal detector 840. According to an embodiment of the beam alignment system 800, the signal detector 840 may be a quadrature detector.

The beam alignment system 800 includes a focusing lens 860. The focusing lens 860 receives the beam carrying the traffic signal from the signal detector 840. The focusing lens 860 focuses the beam carrying the traffic signal onto the core of the second optical cable 870. The signal detector 840, focusing lens 860, and second optical cable 870 are positioned in the beam alignment system 800 such that when a beam carrying the traffic signal is aligned on the signal detector 840, the beam carrying the traffic signal is also aligned on the core of the second optical cable 870. It should be appreciated that the focusing lens 860 may be positioned between the signal detector 840 and the beam steering element 832.

The beam alignment system 800 includes a signal alignment unit 850. The signal alignment unit 850 receives the intensity measurements of the traffic signal from the signal detector 840. The signal alignment unit 850 determines whether the beam carrying the traffic signal is aligned with the signal detector 840 in response to the intensity measurements of the traffic or alignment signal. If the beam carrying the traffic signal is not aligned with the signal detector 840, the signal alignment unit 850 determines how the beam steering elements 831 and 832 should adjust the path of the beam such that the path of the beam is aligned on the signal detector 840.

In an embodiment of the beam alignment detector, where the signal detector measures the intensity of the traffic signal, the sensors on the signal detector may include a material such as indium gallium arsenide, indium gallium phosphide, or germanium that absorbs and thus detects the traffic light.

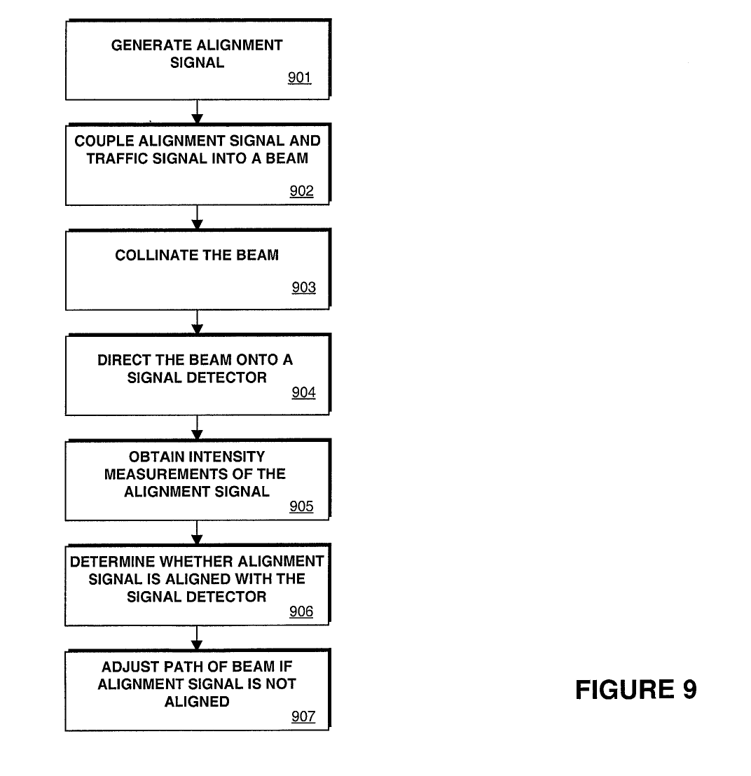

FIG. 9 is a flow chart illustrating a first method of managing a traffic signal having a first wavelength according to an embodiment of the present invention. At step 901, an alignment signal having a second wavelength is generated. According to an embodiment of the present invention, the alignment signal may be generated from a laser or LED source.

At step 902, the alignment signal and the traffic signal are coupled onto a single beam. According to an embodiment of the present invention, coupling the alignment signal and the traffic signal may be achieved with an optical coupler.

At step 903, the beam carrying the traffic signal is collimated. According to an embodiment of the present invention, the traffic signal is collimated using a collimator lens.

At step 904, the beam carrying the traffic is transmitted through a signal detector that transmits signals having the first wavelength and absorbs signals having a second wavelength. According to an embodiment of the present invention, transmitting the beam includes directing the beam with a plurality of beam steering elements, such as MEMS mirrors, to a plurality of output fibers.

At step 905, intensity measurements of the alignment signal on the signal detector are obtained. According to an embodiment of the present invention, obtaining measurements of the alignment signal includes measuring the alignment signal at a plurality of locations where the alignment signal is incident on the signal detector. In one embodiment, this may be achieved using a quadrature detector.

At step 906, it is determined whether the alignment signal is aligned with the signal detector in response to the intensity measurements. According to an embodiment of the present invention, determining whether the alignment signal is aligned with the signal detector includes comparing the intensity measurements with previous intensity measurements taken of an aligned signal.

At step 907, a path of the beam through the signal detector is adjusted if a determination is made that the alignment signal is not aligned with the signal detector. According to an embodiment of the present invention, adjusting the path of the beam includes adjusting the positions of the beam steering elements directing the path of the beam. The path of the beam is adjusted such that the alignment beam is aligned on the signal detector.

It should be appreciated that according to an embodiment of the present invention, a beam carrying the alignment signal may be transmitted to the signal detector before transmitting a beam carrying the traffic signal. This allows for intensity measurements of the alignment beam to be obtained, a determination of whether the alignment signal is aligned with the signal detector to be made, and a path of the alignment beam to be adjusted before the traffic signal is transmitted. This provides the benefit of insuring an aligned beam for carrying traffic signals while minimizing the loss of traffic data.

FIG. 9 is a flow chart that describes a method for managing a traffic signal according to an embodiment of the present invention. The steps illustrated in this figure may be performed in an order other than that which is described. It should be appreciated that not all of the steps described are required to be performed and that some of the illustrated steps may be substituted with other steps.

It should be appreciated that the present invention may be implemented in any system employing free space interconnects between a multitude of fibers. Such devices employing these include optical switches, optical switch cores, wavelength routers, and optical cross-connects.

In the foregoing specification the invention has been described with reference to specific exemplary embodiments thereof. It will, however, be evident that various modifications and changes may be made thereto without departing from the broader spirit and scope of the invention. The specification and drawings are, accordingly, to be regarded in an illustrative rather than restrictive sense.

What is claimed is:

1. A beam alignment system, comprising:
a signal detector in a path of a beam carrying a traffic signal having a first wavelength and an alignment signal having a second wavelength that allows a signal having the first wavelength to be transmitted, the signal detector taking an intensity measurement of the alignment signal;
a signal alignment unit that compares the intensity measurement of the alignment signal to determine whether the alignment signal is aligned on the signal detector; and
a signal director that adjusts the path of the beam on the signal detector in response to the determination of the signal alignment unit.

2. The beam alignment system of claim 1, further comprising a collimator unit that collimates the beam.

3. The beam alignment system of claim 1, wherein the signal detector is a focusing lens that focuses the traffic signal onto an optical cable.

4. The beam alignment system of claim 1, further comprising a focusing lens that focuses the traffic signal onto an optical cable.

5. The beam alignment system of claim 3, wherein the signal detector and the optical cable are positioned such that when the alignment signal is aligned on the signal detector the traffic signal is aligned with a core of the optical cable

6. The beam alignment system of claim 1, wherein the signal detector comprises a plurality of sensors that take intensity measurements of the alignment signal at a plurality of positions on the signal detector.

7. The beam alignment system of claim 6, wherein the signal detector comprises a quadrature detector

8. The beam alignment system of claim 1, wherein the signal director comprises micro-electromechanical systems (MEMS).

9. The beam alignment system of claim 1, wherein the signal detector transmits signals having wavelengths greater than 1300 nanometers.

10. The beam alignment system of claim 1, wherein the detector comprises Si.

11. The beam alignment system of claim 1, wherein the detector comprises InP.

12. The beam alignment system of claim 1, wherein the detector comprises GaP.

13. The beam alignment signal of claim 1, wherein the detector comprises GaAs.

14. The beam alignment system of claim 1, further comprising an alignment signal generator that generates the alignment signal.

15. The beam alignment system of claim 14, wherein the alignment signal is encoded with a pilot tone to aids in connection verification.

16. The beam alignment signal of claim 1, further comprising a signal coupler that couples the alignment signal and the traffic signal onto the beam.

17. A beam alignment system, comprising:
a signal detector that absorbs a portion of a traffic signal, the signal detector taking an intensity measurement of the portion of the traffic signal;
a signal alignment unit that compares the intensity measurement to determine whether the traffic signal is aligned on the signal detector; and
a signal director that adjusts the path of the traffic signal on the signal detector in response to the determination of the signal alignment unit.

18. The beam alignment system of claim 17, wherein the signal detector is a focusing lens that focuses the traffic signal onto an optical cable.

19. The beam alignment system of claim 17, further comprising a focusing lens that focuses the traffic signal onto an optical cable.

20. The beam alignment system of claim 18, wherein the signal detector and the optical cable are positioned such that when the traffic signal is aligned on the signal detector the traffic signal is aligned with a core on in the optical cable.

21. The beam alignment system of claim 17, wherein the signal detector comprises a plurality of sensors that take intensity measurements of the traffic signal at a plurality of positions on the signal detector.

22. The beam alignment system of claim 21, wherein the signal detector comprises a quadrature detector.

23. The beam alignment system of claim 17, wherein the signal director comprises micro-electromechanical systems (MEMS).

24. The beam alignment system of claim 17, wherein the detector comprises Si.

25. The beam alignment system of claim 17, wherein the detector comprises InP.

26. The beam alignment system of claim 17, wherein the detector comprises GaP.

27. The beam alignment system of claim 17, wherein the detector comprises GaAs.

28. A method for managing a traffic signal, comprising:
transmitting a beam carrying the traffic signal having a first wavelength and an alignment signal having a second wavelength to a signal detector that transmits signals having the first wavelength;
obtaining intensity measurements of the alignment signal on the signal detector;
determining whether the alignment signal is aligned with the signal detector in response to the intensity measurements;
adjusting a path of the beam to the signal detector in response to the determination; and verifying connection via pilot tone.

29. The method of claim 28, further comprising:
generating the alignment signal; and
coupling the traffic signal with the alignment signal onto the beam.

30. The method of claim 28, further comprising collimating the beam before transmitting the beam.

31. The method of claim 28, wherein transmitting the beam to the signal detector comprises directing the beam with a plurality of micro-electromechanical systems (MEMS).

32. The method of claim 28, wherein obtaining measurements of the alignment signal comprises measuring the alignment signal at a plurality of locations where the alignment signal is incident on the signal detector.

33. The method of claim 28, wherein determining whether the alignment signal is aligned with the signal detector in response to the intensity measurements comprises comparing the intensity measurements with previous intensity measurements taken of an aligned alignment signal.

34. The method of claim 31, wherein adjusting the path of the beam comprises adjusting the positions of the MEMs.

35. A method for managing a traffic signal, comprising:
transmitting a beam carrying the traffic signal having a first wavelength to a signal detector that transmits signals having the first wavelength;
obtaining intensity measurements of the traffic signal on the signal detector;
determining whether the traffic signal is aligned with the signal detector in response to the intensity measurements; and
adjusting a path of the beam to the signal detector in response to the determination.

36. The method of claim 35, wherein transmitting the beam to the signal detector comprises directing the beam with a plurality of micro-electromechanical systems (MEMS).

37. The method of claim 35, wherein obtaining measurements of the traffic signal comprises measuring the traffic signal at a plurality of locations where the traffic signal is incident on the signal detector.

38. The method of claim 35, wherein determining whether the traffic signal is aligned with the signal detector in response to the intensity measurements comprises comparing the intensity measurements with previous intensity measurements taken of an aligned traffic signal.

39. The method of claim 36, wherein adjusting the path of the beam comprises adjusting the positions of the MEMS.

40. A method for managing a traffic signal, comprising:
transmitting a first beam carrying an alignment signal having a first wavelength to a signal detector that transmits signals having a second wavelength;
obtaining intensity measurements of the alignment signal on the signal detector;
determining whether the alignment signal is aligned with the signal detector in response to the intensity measurements;
adjusting a path of the first beam to the signal detector in response to the determination; and
transmitting a second beam carrying the traffic signal having a second wavelength and the alignment signal having the first wavelength to the signal detector.

41. The method of claim 40, further comprising using beam encoding to aid in connection verification.

42. The method of claim 41, wherein using beam encoding comprises using pilot tones.
